(19) United States
(12) Patent Application Publication
(10) Pub. No.: US 2020/0223681 A1
(43) Pub. Date: Jul. 16, 2020

(54) METHODS AND SYSTEMS FOR A BEVERAGE DISTRIBUTION ASSEMBLY

(71) Applicant: 87K RESEARCH LLC, Fairfield, CT (US)

(72) Inventors: Michel Seth BOISSY, Wallingford, CT (US); Eric T. STEIGELMAN, San Diego, CA (US)

(21) Appl. No.: 16/744,597

(22) Filed: Jan. 16, 2020

Related U.S. Application Data
(60) Provisional application No. 62/793,202, filed on Jan. 16, 2019.

(51) Int. Cl. B67D 1/00; B67D 1/08

(52) U.S. Cl. CPC B67D 1/0021; B67D 1/0045; B67D 1/0857

(57) ABSTRACT

A system and method for providing a pre-mixed beverage from a distribution device that has a first container comprising a first consumable material and a second container comprising a second consumable material. A mixing device arranged in fluid communication with the first container, the second container, and the distribution device such that a mixture of the first consumable material and the second consumable material is formed within the mixing device. At least two pumps are operably coupled to first container, the second container, and the distribution device.

### CROSS-REFERENCE TO RELATED APPLICATIONS

This application claims priority to U.S. Provisional Application No. 62/793,202, entitled “METHODS AND SYSTEMS FOR A BEVERAGE DISTRIBUTION ASSEMBLY,” filed Jan. 16, 2019. The disclosure of the priority application is hereby incorporated in its entirety by reference.

### TECHNICAL FIELD

Aspects of the present disclosure are directed to systems and methods for mixing and distributing beverages.

### BACKGROUND

The preparation and distribution of cold-pressed fresh juice, high pressure processed (“HPP”) beverages, flash pasteurized beverages, shelf stable beverages, pre-mixed cocktails, and other liquids by the process of in line carbonation have become increasingly popular by on-the-go adults and food operators alike because of the quick and ease of delivery of the end product to the consumer.

Foods and beverages, like the ones described above, have traditionally been preserved to prolong their shelf-life through the use of chemical and thermal treatment. Pasteurization via thermal treatments has been recognized as an effective means for inactivating microorganisms such as harmful pathogens that may exist in many unprocessed food and beverage products. If left unchecked, these microorganisms can not only cause premature food and beverage spoilage, but can also result in serious health problems, and sometimes death. Although heating food and beverages effectively reduces levels of microorganisms therein, such processing can alter the fresh and natural taste and flavor of the food and beverages while reducing the natural nutrients therein.

Non-thermal processing of foods, such as HPP, also referred to as high hydrostatic pressure processing or ultra-high pressure processing, is considered a more natural and equally effective means of processing than conventional thermal processing. HPP is used to pasteurize foods at elevated pressures of approximately 30,000 to 130,000 pounds per square inch (“psi”) for a specified temperature and time. The pressure is applied through a pressure medium such as a liquid or a gas. Under these conditions, HPP has been found to be effective in inactivating many pathogenic microorganisms commonly found in foods. As compared to pasteurized liquids, HPP significantly reduces the process temperature and time, which results in foods with improved characteristics such as better retention of freshness, flavor, texture, color, and nutrients.

To date the only method to put these types of beverages on tap is via a standard tap system that is of the kegged beer approach. This includes putting a volume of pressure of gas like CO2 or nitrogen on the top of a stainless steel keg container and pushing out the liquid via the pressure. This method works well, yet the gas comes in contact with the consumable liquids, and thus can carbonate liquids that do not want or cannot handle carbonation. While this method has proven itself appropriate for carbonated beverages like beer, it is not ideal for products that need not carbonation. Like coffee, wine, cocktails, juices, etc.

In view of the foregoing, due to the increased demand for these popular in line carbonated liquids, new methods and systems of mixing, dispensing, and storing these liquids are required in order to try and quench the consumers' never ending thirst for these products. Further advantages and novel features will become apparent from the disclosure provided below.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In one aspect, the disclosure provides a system for providing a pre-mixed beverage from a distribution device that a first container comprising a first consumable material and a second container comprising a second consumable material. A mixing device arranged in fluid communication with the first container, the second container, and the distribution device such that a mixture of the first consumable material and the second consumable material is formed within the mixing device. At least two pumps are operably coupled to first container, the second container, and the distribution device.

In another aspect, the disclosure provides a method for providing a pre-mixed beverage from a distribution device that a first container comprising a first consumable material and a second container comprising a second consumable material. A mixing device arranged in fluid communication with the first container, the second container, and the distribution device such that a mixture of the first consumable material and the second consumable material is formed within the mixing device. At least two pumps are operably coupled to first container, the second container, and the distribution device.

Additional advantages and novel features of the systems and methods of the present disclosure will be set forth in part in the description that follows, and in part will become more apparent to those skilled in the art upon examination of the following or upon learning by practice of the disclosure.

### BRIEF DESCRIPTION OF THE DRAWINGS

The novel features believed to be characteristic of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 is a front view of a system for preparing, storing, mixing and dispensing of consumable liquids output from a distribution device in accordance with aspects of the present disclosure;

FIG. 2 is a perspective view of a container assembly in accordance with aspects of the present disclosure;

FIG. 3 is a detailed front view of the combination unit in accordance with aspects of the present disclosure;

FIG. 4 is a detailed exploded perspective view of the mixing portion in accordance with aspects of the present disclosure.

The detailed description explains embodiments of the present disclosure, together with advantages and features, by way of example with reference to the drawings.

### DETAILED DESCRIPTION OF THE INVENTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

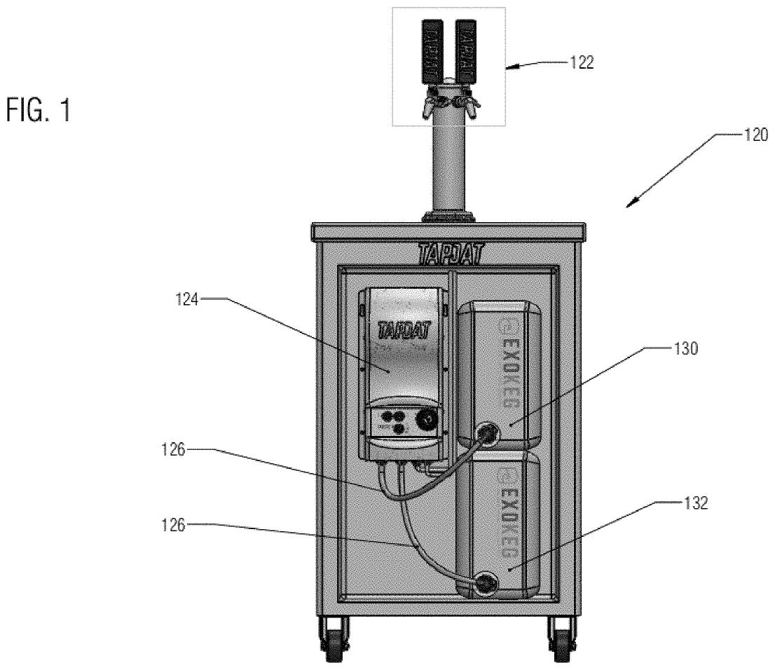

Turning to FIG. 1, is a front view of a system 120 for dispensing liquids, for example, cold-pressed, fresh juice, pre-mixed cocktails, liquor, etc., via a tap, fountain, or distribution device 122 as illustrated. The system 120 may also include a combination unit 124. The combination unit 124 is described in further detail below. The system 120 may also include a first container assembly 132 having an internal cavity containing a plurality of servings of a consumable material. In another aspect, the consumable material may be a single unmixed 100% strength juice, wine, spirits, coffee or a liquid that is consumable or non-consumable. In another aspect, the consumable material may be combined or mixed with another consumable material. The first container assembly 132 assembly will be described in more detail below.

The system 120 may also include a second container assembly 130 having an internal cavity containing a plurality of servings of a consumable material. In another aspect, the consumable material may be a single unmixed 100% strength juice, wine, spirits, coffee or a liquid that is consumable or non-consumable. In another aspect, the consumable material may be combined or mixed with another consumable material. The second container assembly 130 will be described in more detail below.

Upon actuation of the distribution device 122, the combination unit 124 is operated to draw consumable material from the first container assembly 132 and the second container assembly 130, and provide it to the distribution device 122.

The combination unit 124 may be operably coupled via one or more fluid conduits 126 to the second container assembly 130, the first container assembly 132, the distribution device 122 and a gas supply (not shown), for example nitrogen or carbon dioxide. The combination unit 124 may perform a pumping function by pumping from the first container assembly 132, and may perform a pumping function by pumping from the second container assembly 130. Additionally, in another aspect, the combination unit 124 may combine the contents of the first container assembly 132 and the second container assembly 130. The pumping and combination process will be described in detail below. Through the processes conducted by the combination unit 124, via pumping and combining the two different container assembly, the output is dispensed via the distribution device 122. Although the system is described as having a first consumable material and a second consumable material, a system having more than two consumable (or non-consumable) materials is also considered within the scope of the disclosure.

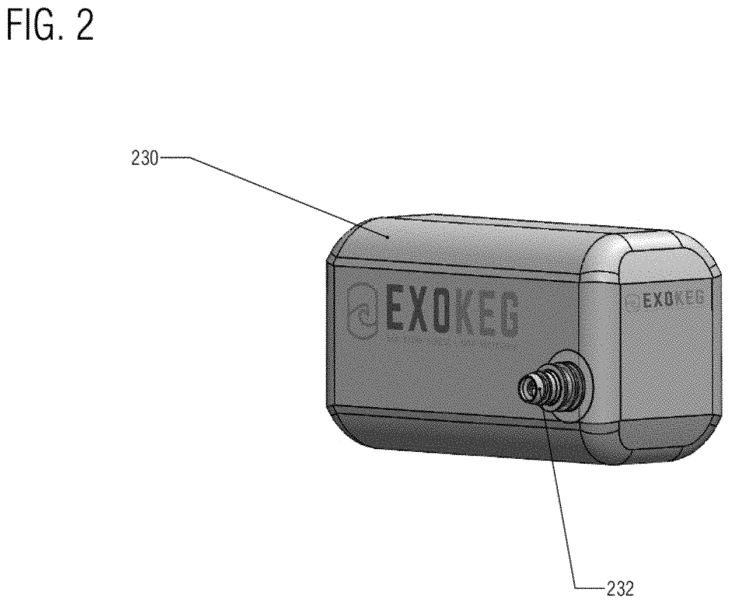

Turning to FIG. 2, is a perspective view of a container assembly 230, for example, the first container assembly 132 or the second container assembly 130. The container assembly 230 may be a carboy and or any other type of ridged or flexible container that can hold or transport liquids. Additionally, the container assembly 230 may be formed in any of a variety of sizes. The container assembly 230 may also comprise a fitting 232 for connecting the container assembly to additional devices such as the combination unit 124 via the fluid conduits 126 shown in FIG. 1. The fluid conduits 126 may be made from FDA approved high oxygen barrier, high acid beverage lines with high flow, no drop quick disconnect fittings. These quick disconnect fittings connect with the fitting 232. The coupling formed by the interface of these “quick connect” fittings allows a user to easily and quickly interrupt or recreate the fluid connection between the devices, for example when replacing a container assembly 230. Although a single container assembly 230 is illustrated in FIG. 2, an unlimited number of container assemblies may be implemented within the system 120 of FIG. 1.

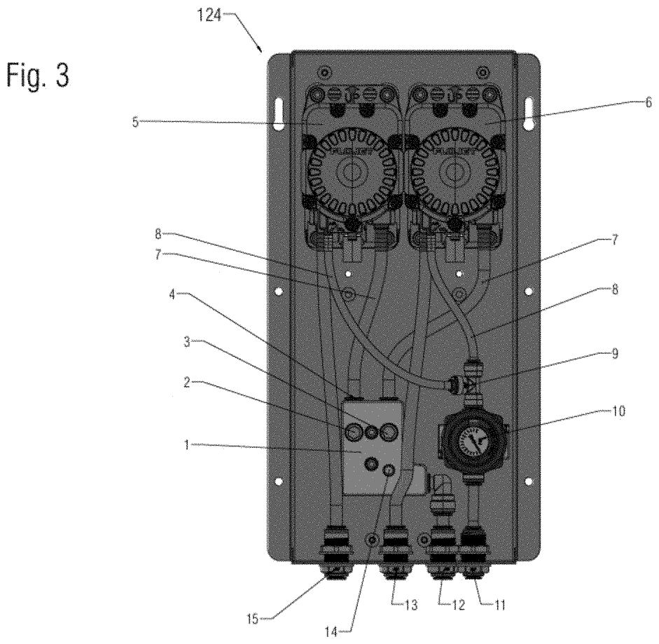

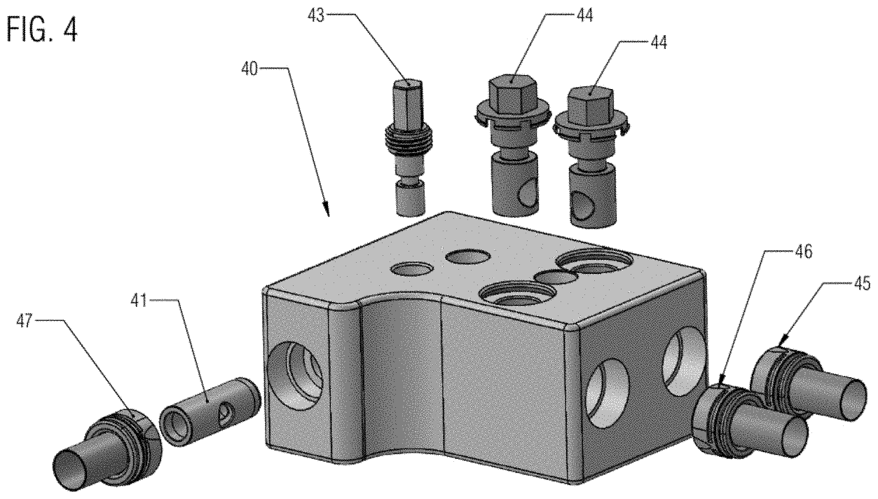

Turning to FIG. 3, is a detailed front view of the combination unit 124 shown in FIG. 1. The combination unit comprises a mixing portion 1, for example a manifold design comprising a venturi mixer or other type of mixing device. The mixing portion 1 may be constructed from FDA approved Polyoxymethylene (POM) such as white Delrin and with FDA approved push to connect beverage fittings. The mixing portion 1 will be described in further detail below in FIG. 4.

Further, the mixing portion may contain a plurality of liquid shut offs, illustrated as shutoffs 2 and 3 in FIG. 3. The shutoffs 2 and 3 may be operated by shutting off the input of liquid obtained via the first container assembly 132 and the second container assembly 130 shown in FIG. 1, directly at the mixing portion 1. At the top of the mixing portion 1, are disconnect liquid lines 4 and 7 that provide liquid from pumps 5 and 6, described below. The liquid is acquired from the first container assembly 132, and the second container assembly 130, both shown in FIG. 1. These disconnect liquid lines 4 and 7 may be designed as a quick disconnect style and made of FDA approved materials such as a high oxygen barrier, high acid beverage lines with high flow, comprising no drop quick disconnect fittings. Connected to the mixing portion 1 via the disconnect liquid lines 4 and 7 are pumps 5 and 6. Although only two pumps are illustrated, additional pumps may be implemented along with additional liquid lines.

Pumps 5 and 6 draw liquid contained in the first container assembly 132 and the second container assembly 130 by intake ports 15 and 13, respectively. The intake ports 15 and 13 may be designed as a quick connect, and are connected to fluid conduits 126 shown in FIG. 1. In one aspect, the liquids contained in the container assemblies are drawn out by, and provided to, pumps 5 and 6. The pumped liquid may then be passed to the mixing portion 1 at different rates of speed or at the same rate of speed. The pumps 5 and 6 may be a type of diaphragm pump, for example, a Flojet G80 high particulate diaphragm pump. Further, the pumps may be air operated by a gas supply (not shown).

The gas supply (not shown) is input to the combination unit 124 via input 11. The gas is passed through an air regulator 10, and then provided to the pumps 5 and 6 via the disconnect air lines 9, and tubes 8. The air regulator may be of a SME type air regulator, and tubes 8 may be of a hi flex super type.

In one aspect, mixing portion 1 is provided with liquids from the first container assembly 132, and the second container assembly 130, via pumps 5 and 6, respectively. Once the liquids are obtained by the mixing portion 1, the liquids may be mixed together, as described in detail below, and provided to output port 12. The output port 12 may be connected via fluid conduits 126 to the distribution device 122, as shown in FIG. 1.

Turning to FIG. 4, is an exploded perspective view of the mixing portion 1 of FIG. 3, herein labeled 40. As described above in relation to FIG. 3, the mixing portion 40 may comprise shutoffs 44. Additionally, the mixing portion 40 may also include a precision adjustment needle 43, as described in detail below. Further, the mixing portion 40 may also include inlets 45 and 46, which connected and provide liquids as described above. The mixing portion may also include a venturi mixer or other type of mixing device 41, as described in detail below. The mixing device 41 is connected to the outlet 47 which provides the mixed liquid to the distribution device 122 of FIG. 1.

The mixing portion may be operable to regulate the amount of one or more of the consumable materials provided thereto. In one aspect, the mixing portion 40 includes a precision adjustment needle 43, such as a set screw for example, arranged adjacent an inlets 45 and 46 for receiving at least one of the first consumable material and the second consumable material. The precision adjustment needle 43 is adjustable to increase or decrease the flow rate, and therefore the amount of a consumable material provided to the mixing portion 40. In another aspect, a precision adjustment needle 43 may be positioned adjacent to each inlet 45 and 46 to provide independent control of the flow rate associated with each of the plurality of consumable materials provided thereto. In an aspect where the first consumable material within the first container assembly 132 is a mixer and the second consumable material within the second container assembly 130 is a corresponding alcohol, the at least one precision adjustment needle 43 may be adjusted to achieve a desired strength or flavor of the mixed beverage output by the distribution device 122. More specifically, the one or more precision adjustment needles 43 may be used to control the ratio of the plurality of consumable materials within the mixing portion 40 and expelled from the distribution device 122.

In one aspect, the mixing portion 40 may be configured receive the flow rate of the first consumable material provided via inlet 46, and the flow rate of the second consumable provided via inlet 45, at the same or roughly the same velocity. In another aspect, the mixing portion 40 may be configured receive the flow rate of the first consumable material provided via inlet 46, and the flow rate of the second consumable provided via inlet 45, at different velocities. Additionally, as described above, the liquids may be manipulated during the blending process.

Turning to the mixing device 41, for example, utilizing precision venturi blending innovations, liquid from first container assembly 132 and liquid from second container assembly 130 may be blended inside the mixing portion 40. In one aspect, the venture blending is accomplished by a venturi tube being placed at the exact position where liquid from second container assembly 130 blends in line with liquid from first container assembly 132. The venturi tube creates a low pressure in the flow line of the liquids being blended and creates a vacuum pulling liquid from first container assembly 132 into the flow at a very precise rate. The use of venturi tube technology provides for less pumps power as well while ensuring consistent and precise blending. The venturi tube that may be used is of FDA white delrin raw material.

As described above, when the process of mixing the liquids is complete, the mixed liquid is sent to the outlet 47, and expelled from the distribution device 122.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A system for distributing beverages, comprising:
a first container configured to accept a first liquid and comprises a first fitting, the first fitting connected to a first tube;
a second container configured to accept a second liquid and comprises a second fitting, the second fitting connected to a second tube;
a mixer comprising a first input configured to receive the first liquid via the first tube, a second input configured to receive the second liquid via the second tube, a combination device configured to combine the first liquid and the second liquid, and an output configured to dispense the combined first liquid and second liquid,
wherein the combination device comprises a venturi mixer and an adjustment needle.

2. The system of claim 1, further comprising a tap connected to the output via a third tube, and configured to dispense the combined first liquid and second liquid.

3. The system of claim 1, wherein the first container, the second container and the mixer are contained within a refrigeration device.

4. The system of claim 1, wherein the first liquid and the second liquid are different liquids.

5. The system of claim 1, wherein the mixer further comprises a third input configured to receive a compressed gas, and wherein the combined first liquid and the second liquid further comprises the compressed gas.

6. The system of claim 1, wherein the adjustment needle is configured to regulate the combined first liquid and the second liquid based on regulating a flow rate of the first liquid or the second liquid.

7. The system of claim 1, wherein the first liquid comprises an alcoholic beverage and the second liquid comprises a non-alcoholic beverage.

8. A method for mixing and distributing beverages, comprising:
receiving by a combiner a first liquid from a first container via a first tube;
receiving by the combiner a second liquid from a second container via a second tube;
combining the received first liquid and the received second liquid by a venturi mixer; and
outputting by the combiner the combined first liquid and second liquid to a dispenser, wherein the venturi mixer comprises an adjustment needle.

9. The method of claim 8, further comprising dispending the combined first liquid and second liquid via a tap connected to the combiner via a third tube.

10. The method of claim 8, wherein the first container, the second container and the combiner are contained within a refrigeration device.

11. The method of claim 8, wherein the first liquid and the second liquid are different liquids.

12. The method of claim 8, wherein the combining further comprises receiving a compressed gas, and wherein the combined first liquid and the second liquid further comprises the compressed gas.

13. The method of claim 8, wherein the adjustment needle is configured to regulate the combined first liquid and the second liquid based on regulating a flow rate of the first liquid or the second liquid.

14. The method of claim 8, wherein the first liquid comprises an alcoholic beverage and the second liquid comprises a non-alcoholic beverage.
